(19) United States
(12) Patent Application Publication
(10) Pub. No.: US 2025/0117195 A1
(43) Pub. Date: Apr. 10, 2025

(54) AI-MODIFIED CODE RECOMMENDATION IN CONTEXT OF A DEVELOPER TOOL

(71) Applicant: Microsoft Technology Licensing, LLC, Redmond, WA (US)

(72) Inventors: Johannes RIEKEN, Zürich (CH); Matthew Joseph BIERNER, Lake Forest Park, WA (US); Alexandru Ioan DIMA, Zürich (CH); David Christopher DOSSETT, Seattle, WA (US); Kai-Uwe MAETZEL, Seattle, WA (US)

(21) Appl. No.: 18/482,842

(22) Filed: Oct. 6, 2023

(51) Int. Cl. G06F 8/35; G06F 8/33

(52) U.S. Cl. CPC G06F 8/35; G06F 8/33

(57) ABSTRACT

Techniques are described herein that are capable of providing a recommendation of AI-modified code in context of a developer tool. Based at least on code being developed in a developer tool, an interface element is provided in a user interface of the developer tool. The interface element is configured to receive a prompt that specifies a modification to be performed on the code. Based at least on receipt of the prompt, an AI model is automatically caused to perform the modification on at least a snippet of the code to provide a modified snippet. The modified snippet is processed using a language intelligence tool of the developer tool to provide a processed version of the modified snippet. A recommendation to replace the snippet in the code with the modified snippet is provided by causing the processed version of the modified snippet to be displayed via the user interface.

### BACKGROUND

Code developers typically utilize a developer tool to develop code (e.g., software or firmware). Development of code (i.e., code development) is a process that extends from conception of the code through a final manifestation of the code. For instance, the development of the code may include conceiving, specifying, designing, programming, documenting, testing, and debugging the code. A developer tool is a computer program that performs diagnostic operations (e.g., identifying source of an error in the code, fixing the error, and analyzing runtime attributes) with respect to program code. Examples of a developer tool include but are not limited to an integrated development environment (IDE) and a web development platform. A developer tool traditionally is limited to processing information that is included in a file that includes the program code.

### SUMMARY

It may be desirable to use artificial intelligence (AI) to modify code that is being developed in context of a developer tool so that the modified code can be suggested to a developer of the code in the context of the developer tool. For example, the developer may provide a request via an artificial intelligence prompt, requesting for an artificial intelligence model to implement a particular change to the code. Upon receiving modified code, including the particular change, from the artificial intelligence model, the modified code can be presented to the developer in the context of the developer tool. The developer may choose to accept the modified code, discard the modified code, or make further changes to the modified code (e.g., manually or by issuing a request for the further changes via another artificial intelligence prompt). Using artificial intelligence to implement desired changes to code that is being developed in a developer tool may result in the code being developed more quickly and efficiently.

An artificial intelligence prompt indicates (e.g., specifies) a task that is to be performed by an artificial intelligence model. In an aspect, the artificial intelligence prompt is written in natural language. Examples of an artificial intelligence prompt include but are not limited to a zero-shot prompt, a one-shot prompt, and a few-shot prompt. A zero-shot prompt is a prompt for which the prompt and/or its corresponding contextual information, which are to be processed by the artificial intelligence model, is not included in pre-trained knowledge of the artificial intelligence model. A one-shot prompt is a prompt that includes a target prompt along with a single example prompt and a single example answer that is responsive to the single example prompt. The example prompt and the example answer provide guidance as to how the artificial intelligence model is expected to respond to the target prompt. A few-shot prompt is a prompt that includes a target prompt along with multiple example prompts and multiple example answers that are responsive to the respective example prompts. The example prompts and the example answers provide guidance as to how the artificial intelligence model is expected to respond to the target prompt.

An artificial intelligence model is a model that utilizes artificial intelligence to generate an answer that is responsive to an artificial intelligence prompt (a.k.a. prompt) that is received by the artificial intelligence model. The artificial intelligence model may be an artificial general intelligence model. An artificial general intelligence model is an artificial intelligence model (e.g., an autonomous artificial intelligence model) that is configured to be capable of performing any task that an animal (e.g., a human) is capable of performing. In an example implementation, the artificial general intelligence model is capable of performing a task that surpasses the capabilities of an animal. Artificial intelligence is intelligence of a machine (e.g., a processing system) and/or code (e.g., software and/or firmware), as opposed to intelligence of an animal (e.g., a human).

Various approaches are described herein for, among other things, providing a recommendation of AI-modified code (i.e., code that is modified using artificial intelligence) in context of a developer tool. In an example approach, based at least on (e.g., as a result of or in response to) code being developed in a developer tool, an interface element is provided in a user interface of the developer tool. The interface element is configured to receive an artificial intelligence prompt that specifies a modification to be performed on the code. Based at least on receipt of the artificial intelligence prompt via the interface element, an artificial intelligence model is automatically caused to perform the modification on at least a snippet of the code. In an example implementation, the artificial intelligence model is automatically caused to perform the modification by providing the artificial intelligence prompt together with the snippet as inputs to the artificial intelligence model. In accordance with this implementation, the snippet includes context regarding the artificial intelligence prompt. A modified snippet is received from the artificial intelligent model. The modified snippet results from the artificial intelligence model performing the modification specified by the artificial intelligence prompt. The modified snippet is processed using a language intelligence tool of the developer tool to provide a processed version of the modified snippet. A recommendation to replace the snippet in the code with the modified snippet is provided by causing the processed version of the modified snippet to be displayed via the user interface of the developer tool.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example AI-modified code recommendation system in accordance with an embodiment.

FIGS. 2-4 depict flowcharts of example methods for recommending AI-modified code in context of a developer tool in accordance with embodiments.

FIG. 5 is a block diagram of an example computing system in accordance with an embodiment.

FIG. 6 depicts example code presented in a user interface of a developer tool in accordance with an embodiment.

FIG. 7 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to use artificial intelligence (AI) to modify code that is being developed in context of a developer tool so that the modified code can be suggested to a developer of the code in the context of the developer tool. For example, the developer may provide a request via an artificial intelligence prompt, requesting for an artificial intelligence model to implement a particular change to the code. Upon receiving modified code, including the particular change, from the artificial intelligence model, the modified code can be presented to the developer in the context of the developer tool. The developer may choose to accept the modified code, discard the modified code, or make further changes to the modified code (e.g., manually or by issuing a request for the further changes via another artificial intelligence prompt). Using artificial intelligence to implement desired changes to code that is being developed in a developer tool may result in the code being developed more quickly and efficiently.

Example embodiments described herein are capable of providing a recommendation of AI-modified code (i.e., code that is modified using artificial intelligence) in context of a developer tool. The example embodiments are described with reference to artificial intelligence prompts and artificial intelligence models. An artificial intelligence prompt indicates (e.g., specifies) a task that is to be performed by an artificial intelligence model. In an aspect, the artificial intelligence prompt is written in natural language. Examples of an artificial intelligence prompt include but are not limited to a zero-shot prompt, a one-shot prompt, and a few-shot prompt. A zero-shot prompt is a prompt for which the prompt and/or its corresponding contextual information, which are to be processed by the artificial intelligence model, is not included in pre-trained knowledge of the artificial intelligence model. A one-shot prompt is a prompt that includes a target prompt along with a single example prompt and a single example answer that is responsive to the single example prompt. The example prompt and the example answer provide guidance as to how the artificial intelligence model is expected to respond to the target prompt. A few-shot prompt is a prompt that includes a target prompt along with multiple example prompts and multiple example answers that are responsive to the respective example prompts. The example prompts and the example answers provide guidance as to how the artificial intelligence model is expected to respond to the target prompt.

An artificial intelligence model is a model that utilizes artificial intelligence to generate an answer that is responsive to an artificial intelligence prompt (a.k.a. prompt) that is received by the artificial intelligence model. The artificial intelligence model may be an artificial general intelligence model. An artificial general intelligence model is an artificial intelligence model (e.g., an autonomous artificial intelligence model) that is configured to be capable of performing any task that an animal (e.g., a human) is capable of performing. In an example implementation, the artificial general intelligence model is capable of performing a task that surpasses the capabilities of an animal. Artificial intelligence is intelligence of a machine (e.g., a processing system) and/or code (e.g., software and/or firmware), as opposed to intelligence of an animal (e.g., a human).

Example techniques described herein have a variety of benefits as compared to conventional techniques for development of code in context of a developer tool. For instance, the example techniques are capable of using artificial intelligence to modify code that is being developed in context of a developer tool so that the modified code can be suggested to a developer of the code in the context of the developer tool. Using the artificial intelligence to generate the modified code may result in the code being developed more quickly and efficiently. The example techniques enable the developer to specify a particular modification, which an artificial intelligence model is to perform on the code, in an artificial intelligence prompt that is received from the developer via a user interface of the developer tool. By providing the artificial intelligence prompt together with at least a snippet of the code, which provides context for the artificial intelligence prompt, the example techniques enable the artificial intelligence model to generate an answer to the artificial intelligence prompt that includes the modified code.

The example techniques may reduce an amount of time and/or resources (e.g., processor cycles, memory, network bandwidth) that is consumed to develop code in context of a developer tool. For example, automatically causing an artificial intelligence model to perform a modification, which is specified by an artificial intelligence prompt received via a user interface of the developer tool, on at least a snippet of the code, processing the resulting modified snippet using a language intelligence tool of the developer tool, and/or providing a recommendation to replace the snippet in the code with the modified snippet may reduce the amount of time and/or resources that is consumed by a computing system to develop the code in the context of the developer tool. In accordance with this example, any of the aforementioned operations (e.g., automatically causing the artificial intelligence model to perform the modification, processing the resulting modified snippet, and/or providing the recommendation) may reduce an amount of time and/or resources that would have otherwise been consumed by the computing system as a result of the developer attempting to modify the code manually (e.g., by utilizing functionality of the developer tool). By reducing the amount of time and/or resources that is consumed, the efficiency of the computing system may be increased.

The example techniques may increase a user experience of a developer who develops code in the context of the developer tool. For instance, the example techniques may automate operations that otherwise would be performed by the developer, which may reduce an amount of time consumed and/or effort expended by the developer to develop the code. The example techniques may increase an efficiency of the user by reducing the amount of time that the developer otherwise would have consumed to develop the code.

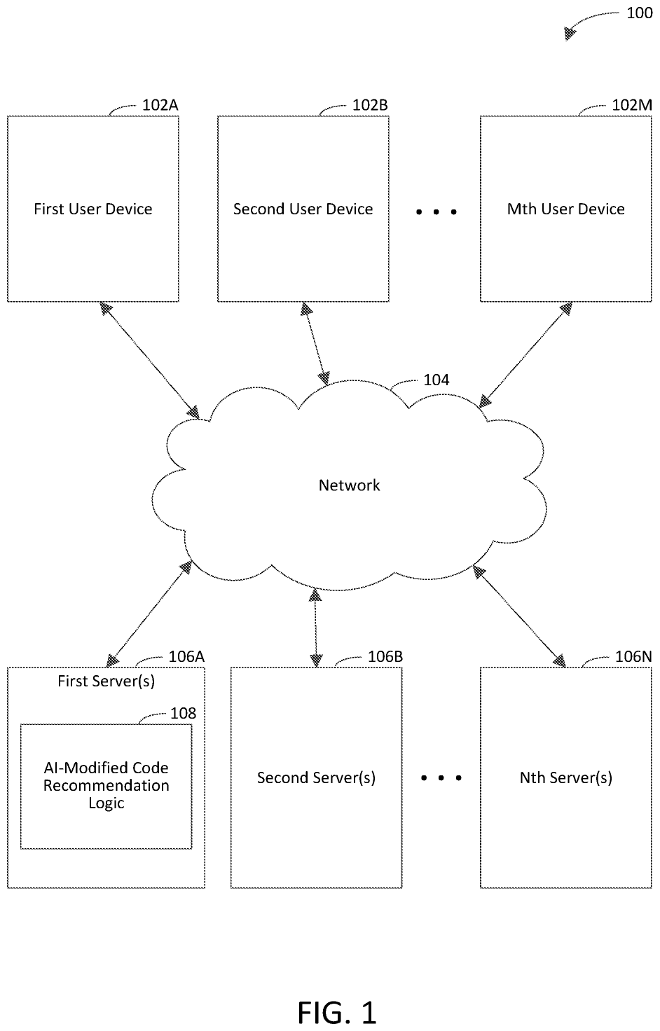

FIG. 1 is a block diagram of an example AI-modified code recommendation system 100 in accordance with an embodiment. Generally speaking, the AI-modified code recommendation system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the AI-modified code recommendation system 100 provides a recommendation of AI-modified code (i.e., code that is modified using artificial intelligence) in context of a developer tool. Detail regarding techniques for providing a recommendation of AI-modified code in context of a developer tool is provided in the following discussion.

As shown in FIG. 1, the AI-modified code recommendation system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the complex expression-based metadata generation system 100.

One example type of computer program that may be executed by one or more of the servers 106A-106N is a developer tool. A developer tool is a computer program that performs diagnostic operations (e.g., identifying source of problem, debugging, profiling, controlling, etc.) with respect to program code. Examples of a developer tool include but are not limited to an integrated development environment (IDE) and a web development platform. Examples of an IDE include but are not limited to Microsoft Visual Studio® IDE developed and distributed by Microsoft Corporation; AppCode® IDE, PhpStorm® IDE, Rider® IDE, WebStorm® IDE, etc. developed and distributed by JetBrains s.r.o.; JDeveloper® IDE developed and distributed by Oracle International Corporation; NetBeans® IDE developed and distributed by Sun Microsystems, Inc.; Eclipse™ IDE developed and distributed by Eclipse Foundation; and Android Studio™ IDE developed and distributed by Google LLC and JetBrains s.r.o. Examples of a web development platform include but are not limited to Windows Azure® platform developed and distributed by Microsoft Corporation; Amazon Web Services® platform developed and distributed by Amazon.com, Inc.; Google App Engine® platform developed and distributed by Google LLC; VMWare® platform developed and distributed by VMWare, Inc.; and Force.com® platform developed and distributed by Salesforce, Inc. It will be recognized that the example techniques described herein may be implemented using a developer tool.

Another example type of a computer program that may be executed by one or more of the servers 106A-106N is a cloud computing program (a.k.a. cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). For example, IaaS may provide to the user virtualized computing resources that utilize the IaaS provider's physical computer resources.

Examples of a cloud computing program include but are not limited to Google Cloud® developed and distributed by Google Inc., Oracle Cloud® developed and distributed by Oracle Corporation, Amazon Web Services® developed and distributed by Amazon.com, Inc., Salesforce® developed and distributed by Salesforce.com, Inc., AppSource® developed and distributed by Microsoft Corporation, Azure® developed and distributed by Microsoft Corporation, GoDaddy® developed and distributed by GoDaddy.com LLC, and Rackspace® developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include AI-modified code recommendation logic 108 for illustrative purposes. The AI-modified code recommendation logic 108 is configured to provide a recommendation of AI-modified code (i.e., code that is modified using artificial intelligence) in context of a developer tool. In an example implementation, based at least on (e.g., as a result of or in response to) code being developed in a developer tool, the AI-modified code recommendation logic 108 provides an interface element in a user interface of the developer tool. The interface element is configured to receive an artificial intelligence prompt that specifies a modification to be performed on the code. Based at least on receipt of the artificial intelligence prompt via the interface element, the AI-modified code recommendation logic 108 automatically causes an artificial intelligence model to perform the modification on at least a snippet of the code. In an example implementation, the AI-modified code recommendation logic 108 automatically causes the artificial intelligence model to perform the modification by providing the artificial intelligence prompt together with the snippet as inputs to the artificial intelligence model. In accordance with this implementation, the snippet includes context regarding the artificial intelligence prompt. The AI-modified code recommendation logic 108 receives a modified snippet from the artificial intelligent model. The modified snippet results from the artificial intelligence model performing the modification specified by the artificial intelligence prompt. The AI-modified code recommendation logic 108 processes the modified snippet using a language intelligence tool of the developer tool to provide a processed version of the modified snippet. The AI-modified code recommendation logic 108 provides a recommendation to replace the snippet in the code with the modified snippet by causing the processed version of the modified snippet to be displayed via the user interface of the developer tool.

The AI-modified code recommendation logic 108 may be implemented in various ways to provide a recommendation of AI-modified code in context of a developer tool, including being implemented in hardware, software, firmware, or any combination thereof. For example, the AI-modified code recommendation logic 108 may be implemented as computer program code configured to be executed in one or more processors. In another example, at least a portion of the AI-modified code recommendation logic 108 may be implemented as hardware logic/electrical circuitry. For instance, at least a portion of the AI-modified code recommendation logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the AI-modified code recommendation logic 108 may be (or may be included in) a developer tool and/or a cloud computing program, though the scope of the example embodiments is not limited in this respect.

The AI-modified code recommendation logic 108 is shown to be incorporated in the first server(s) 106A for illustrative purposes and is not intended to be limiting. It will be recognized that the AI-modified code recommendation logic 108 (or any portion(s) thereof) may be incorporated in any one or more of the servers 106A-106N, any one or more of the user devices 102A-102M, or any combination thereof. For example, client-side aspects of the AI-modified code recommendation logic 108 may be incorporated in one or more of the user devices 102A-102M, and server-side aspects of AI-modified code recommendation logic 108 may be incorporated in one or more of the servers 106A-106N.

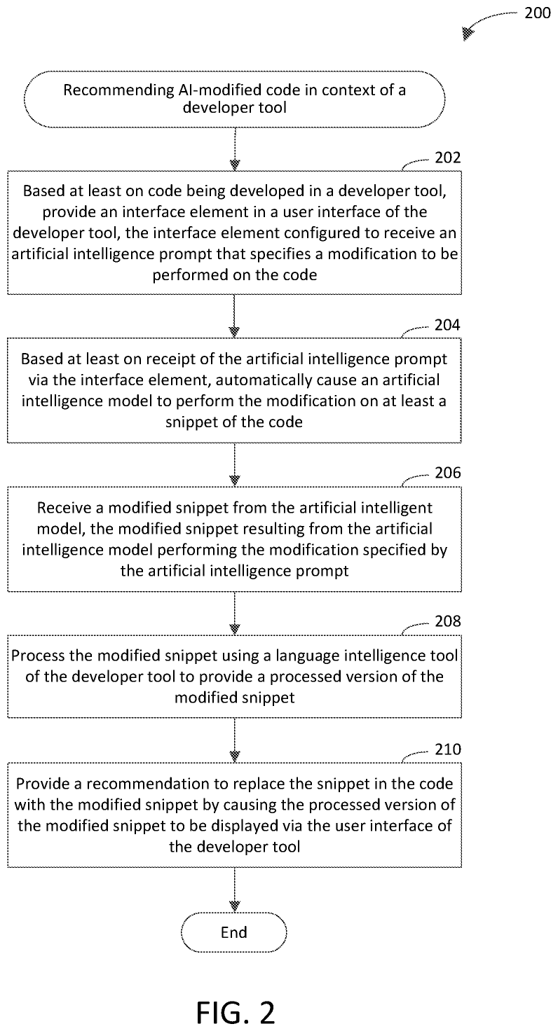

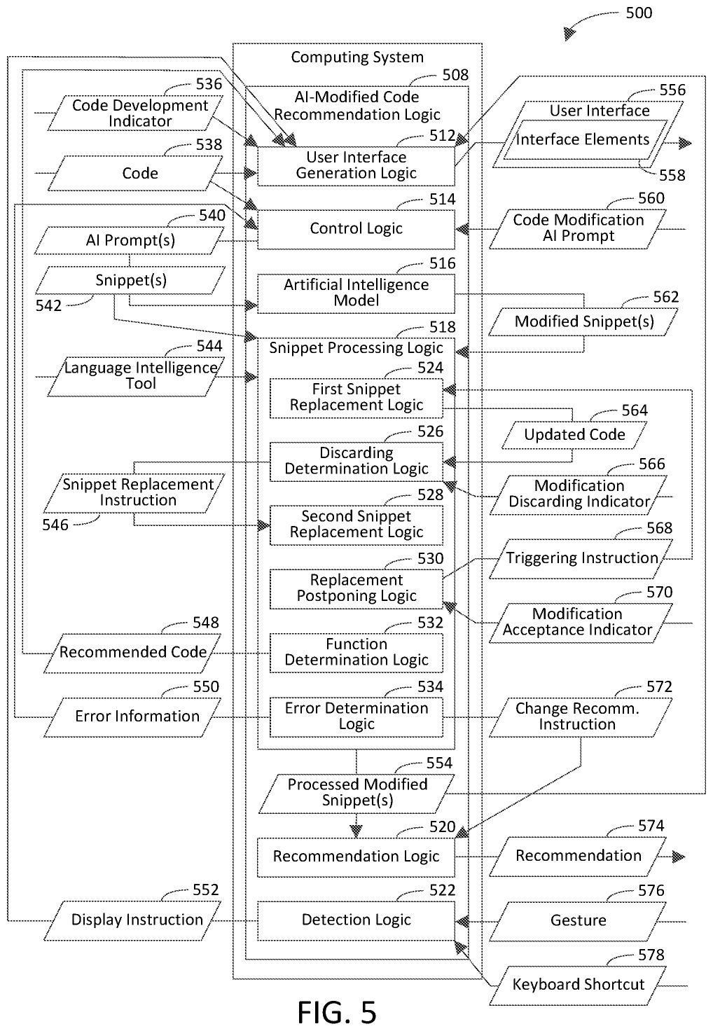

FIGS. 2-4 depict flowcharts 200, 300, and 400 of example methods for recommending AI-modified code in context of a developer tool in accordance with embodiments. Flowcharts 200, 300, and 400 may be performed by the first server(s) 106A shown in FIG. 1, for example. For illustrative purposes, flowcharts 200, 300, and 400 are described with respect to a computing system 500 shown in FIG. 5, which is an example implementation of the first server(s) 106A. As shown in FIG. 5, the computing system 500 includes AI-modified code recommendation logic 508. The AI-modified code recommendation logic 508 includes user interface generation logic 512, control logic 514, an artificial intelligence model 516, snippet processing logic 518, recommendation logic 520, and detection logic 522. The snippet processing logic 518 includes first snippet replacement logic 524, discarding determination logic 526, second snippet replacement logic 528, replacement postponing logic 530, function determination logic 532, and error determination logic 534. Further structural and operational embodiments will be apparent to persons skilled in the relevant art(s) based on the discussion regarding flowcharts 200, 300, and 400.

As shown in FIG. 2, the method of flowchart 200 begins at step 202. In step 202, based at least on (e.g., as a result of or in response to) code being developed in a developer tool, an interface element is provided in a user interface of the developer tool. The interface element is configured to receive an artificial intelligence prompt that specifies a modification to be performed on the code. For instance, providing the interface element in the user interface may be further based on (e.g., triggered by) a designated keyboard shortcut. A keyboard shortcut (a.k.a. hotkey) is a single keystroke or a series of keystrokes that causes a preprogrammed action to be performed. In an example implementation, based at least on code 538 being developed in a developer tool, the user interface generation logic 512 provides an interface element, which is included in interface elements 558, in a user interface 556 of the developer tool. The interface element is configured to receive a code modification artificial intelligence (AI) prompt 560 that specifies the modification to be performed on the code 538.

At step 204, based at least on receipt of the artificial intelligence prompt via the interface element, an artificial intelligence model is automatically caused to perform the modification on at least a snippet of the code. In an aspect, the artificial intelligence model is automatically caused to perform the modification at step 204 by providing the artificial intelligence prompt together with the snippet as inputs to the artificial intelligence model. In accordance with this aspect, the snippet includes context regarding the artificial intelligence prompt. In another aspect, the code (e.g., the snippet of the code) is not included in the artificial intelligence prompt. For example, the artificial intelligence prompt may be written by a developer of the code. In accordance with this example, the snippet may be provided as a system-generated prompt along with the artificial intelligence prompt to the artificial intelligence model for processing. A system-generated prompt is a prompt that is generated (e.g., created) by a computing system, rather than a human. In yet another aspect, the interface element in the user interface of the developer tool enables the developer to conduct an in-line chat with the artificial intelligence model. In accordance with this aspect, the artificial intelligence prompt is a communication from the developer in the in-line chat. In an example implementation, based at least on receipt of the code modification AI prompt 560 via the interface element, the control logic 514 automatically causes the artificial intelligence model 516 to perform the modification on at least a snippet of the code 538 to provide a modified code snippet, which is included in modified snippet(s) 562. In an aspect, the control logic 514 automatically causes the artificial intelligence model 516 to perform the modification by providing the code modification AI prompt 560 together with the snippet as inputs to the artificial intelligence model 516. In accordance with this aspect, the snippet includes context regarding the code modification AI prompt 560. For example, the code modification AI prompt 560 may be included in the AI prompt(s) 540. In another example, the snippet may be included in the snippet(s) 542. In yet another example, the code modification AI prompt 560 may be written by a developer of the code 538. In accordance with this example, the control logic 514 may generate (e.g., automatically generate) a system-generated prompt that includes the snippet based at least on the code modification AI prompt 560. In further accordance with this example, the control logic 514 may provide the code modification AI prompt 560 together with the system-generated prompt, which includes context regarding the code modification AI prompt 560, as inputs to the artificial intelligence model 516.

In an example embodiment, the artificial intelligence model is a large language model (LLM). A large language model is an artificial neural network that is capable of performing natural language processing (NLP) tasks. For instance, the large language model may use a transformer model to perform the NLP tasks. In an aspect, the large language model is trained (e.g., pre-trained) using self-supervised learning and semi-supervised learning. Examples of a large language model include but are not limited to the GPT-3 and GPT-4 models, developed and distributed by OpenAI, Inc.; the LLaMA model, developed and distributed by Meta Platforms Inc.; and the PALM model, developed and distributed by Google LLC.

At step 206, a modified snippet is received from the artificial intelligent model. The modified snippet results from the artificial intelligence model performing the modification specified by the artificial intelligence prompt. In an example implementation, the snippet processing logic 518 receives the modified snippet from the artificial intelligent model 516. In accordance with this implementation, the modified snippet is a result of the artificial intelligence model 516 performing the modification specified by the code modification AI prompt 560 on the snippet (e.g., in response to the control logic 514 providing the code modification AI prompt 560, which is included in the AI prompts 540, together with the snippet, which is included in the snippet(s) 542, as the inputs to the artificial intelligence model 516). The modified snippet is included in the processed modified snippet(s) 554.

At step 208, the modified snippet is processed using a language intelligence tool of the developer tool to provide a processed version of the modified snippet. A language intelligence tool is a computer program that uses artificial intelligence to process (e.g., understand) human language. For example, the language intelligence tool may be configured to identify words and phrases, understand grammar, interpret meaning, and produce human-readable text. The language intelligence tool may be configured to provide code refactoring functionality and programming language-specific functionality, such as intelligent code completion, syntax highlighting, and marking of warnings and errors. Code refactoring (i.e., refactoring of code) is a process of restructuring the code without changing external behavior of the code. Intelligent code completion is context-aware code completion. Code completion is a process of predicting a next portion of the code that a developer is writing. Syntax highlighting is a process of causing different portions of text, such as code, (e.g., different lexical sub-elements of syntax) to be displayed in different colors and/or text styles (e.g., fonts) based at least on categories to which the different portions are assigned. Examples of a portion of text include but are not limited to a comment, a control-flow statement, a keyword, and a variable. Marking of a warning or an error in code may include underlining a portion of the code to which the warning or error applies (e.g., using a red squiggly line). The language intelligence tool may enable usage of all functionalities of the developer tool with regard to the modified snippet. Accordingly, the language intelligence tool may be used to process the modified snippet using any of the aforementioned functionalities (e.g., code refactoring, intelligent code completion, syntax highlighting, and/or marking of warnings and errors) to generate the processed version of the modified snippet. The language intelligence tool may be configured in accordance with the language server protocol (LSP). The LSP is an open, JSON-RPC-based protocol for use between a source code editor or an integrated development environment (IDE) and a server that hosts the language intelligence tool. In an example implementation, the snippet processing logic 518 processes the modified snippet using a language intelligence tool 544 of the developer tool to provide the processed version of the modified snippet, which is included in the processed modified snippet(s) 554.

At step 210, a recommendation to replace the snippet in the code with the modified snippet is provided by causing the processed version of the modified snippet to be displayed via the user interface of the developer tool. In an example implementation, the recommendation logic 520 provides a recommendation 574 to replace the snippet in the code 538 with the modified snippet by causing the processed version of the modified snippet, which is included in the processed modified snippet(s) 554, to be displayed via the user interface of the developer tool.

In an example embodiment, causing the processed version of the modified snippet to be displayed at step 210 includes causing the snippet and the processed version of the modified snippet to be displayed simultaneously (e.g., side-by-side) via the user interface.

In another example embodiment, causing the processed version of the modified snippet to be displayed via the user interface at step 210 is performed based at least on a cursor being located in the snippet at a time instance at which the artificial intelligence prompt is received. For example, the cursor being located in the snippet may mean that a position of the cursor is within a boundary that is defined by the snippet. In another example, the snippet may be a function in the code, a method in the code, or an entirety of the code (e.g., a file that includes the code).

In yet another example embodiment, causing the processed version of the modified snippet to be displayed via the user interface at step 210 is performed based at least on the artificial intelligence prompt being received while an entirety of text that is included in the snippet is selected (e.g., highlighted) in accordance with a user-generated instruction.

In still another example embodiment, processing the modified snippet at step 208 includes annotating the modified snippet using the language intelligence tool of the developer tool to provide the processed version of the modified snippet having an annotation. An annotation of a snippet is a comment about the snippet. In an aspect, text in the modified snippet is annotated with the annotation such that the annotation is distinguishable (e.g., syntactically distinguishable) from the text in the modified snippet that is annotated with the annotation. In accordance with this embodiment, causing the processed version of the modified snippet to be displayed at step 210 includes causing the processed version of the modified snippet, including the annotation, to be displayed via the user interface.

In another example embodiment, processing the modified snippet at step 208 includes highlighting instances of a designated symbol (e.g., variable name or function name) in the modified snippet using the language intelligence tool of the developer tool to provide the processed version of the modified snippet. In accordance with this embodiment, causing the processed version of the modified snippet to be displayed at step 210 includes causing the processed version of the modified snippet, including highlighted instances of the designated symbol, to be displayed via the user interface.

In yet another example embodiment, processing the modified snippet at step 208 includes distinguishing a designated portion of the modified snippet from a remainder of the modified snippet by marking the designated portion with an error indicator using the language intelligence tool of the developer tool to provide the processed version of the modified snippet. The error indicator indicates that a programming error occurs with regard to the designated portion of the modified snippet. In accordance with this embodiment, causing the processed version of the modified snippet to be displayed at step 210 includes causing the processed version of the modified snippet, which includes the error indicator, to be displayed via the user interface.

In some example embodiments, one or more steps 202, 204, 206, 208, and/or 210 of flowchart 200 may not be performed. Moreover, steps in addition to or in lieu of steps 202, 204, 206, 208, and/or 210 may be performed. For instance, in an example embodiment, the method of flowchart 200 further includes detecting a gesture regarding a symbol, which is included in the processed version of the modified snippet, while the processed version of the modified snippet is displayed via the user interface. A gesture may be a touch gesture (e.g., touchpad gesture or touchscreen gesture), a hover gesture, or a combination thereof. A touch gesture is a gesture in which a user touches a touchpad or a touchscreen of a computing system. Examples of a touch gesture include but are not limited to a tap, a double tap, a long press, a pan, a flick, a pinch, a zoom, a rotate, a scroll or swipe, a two-finger tap, and a two-finger scroll. A hover gesture is a gesture that does not require a user to touch a touchpad or a touchscreen of a computing system. For instance, the user may perform the hover gesture by placing a hand and/or finger(s) at a spaced distance above a touchscreen. It will be recognized that the touchscreen can detect that the user's hand and/or finger(s) are proximate to the touchscreen (e.g., through capacitive sensing). Additionally, hand rotation and finger movement can be detected while the hand and/or finger(s) are hovering. Examples of a hover gesture include but are not limited to finger hover pan (e.g., float a finger above a screen and pan the finger in any direction); a finger hover flick (e.g., float a finger above the screen and quickly flick the finger); a finger hover circle (e.g., float a finger above the screen and draw a circle or counter-circle in the air); a finger hover hold (e.g., float a finger above the screen and keep the finger stationary); a palm swipe (e.g., float the edge of the hand or the palm of the hand and swipe across the screen); an air pinch/lift/drop (e.g., use the thumb and pointing finger to perform a pinch gesture above the screen, a drag motion, then a release motion); and a hand wave gesture (e.g., float the hand above the screen and move the hand back and forth in a hand-waving motion). It will be recognized that gestures may be detected in other ways, such as using a camera. In such instances, the user need not necessarily perform a hover gesture in proximity to a touchscreen. Rather, the user may perform the gesture in a field of view of a camera to enable the camera to detect the gesture. In an aspect, the gesture involves the cursor hovering over the symbol. In an example implementation, the detection logic 522 detects a gesture 576 regarding the symbol while the processed version of the modified snippet, which is included in the processed modified snippet(s) 554, is displayed via the user interface 556. In accordance with this embodiment, the method of flowchart 200 further includes, based at least on the gesture, providing information about the symbol in an interface element of the user interface. In an aspect, the symbol includes a name of a function, and the information about the symbol indicates (e.g., identifies or specifies) a creator of the function. In an example implementation, based at least on the gesture, the user interface generation logic 512 provides the information about the symbol in an interface element of the user interface 556. The interface element is included in the interface elements 558.

In an aspect of this embodiment, the information about the symbol is provided in the interface element of the user interface while the processed version of the modified snippet is displayed via the user interface.

In an example error fixing embodiment, the method of flowchart 200 further includes determining that replacement of the snippet in the code with the modified snippet causes the code to include a programming error. In an example implementation, the error determination logic 534 determines that replacement of the snippet in the code 538 with the modified snippet causes the code 538 to include the programming error. In accordance with this embodiment, the error determination logic 534 generates error information 550 to indicate (e.g., specify or describe) the programming error. In accordance with this embodiment, the method of flowchart 200 further includes causing the artificial intelligence model to correct the programming error by providing a second artificial intelligence prompt, which specifies that the programming error is to be corrected, together with at least a portion of the code that includes the programming error as second inputs to the artificial intelligence model. The second artificial intelligence prompt may be a system-generated prompt or a prompt that is generated by a developer of the code. The portion of the code that includes the programming error includes context regarding the second artificial intelligence prompt. In an aspect, the portion of the code that includes the programming error is included in the modified snippet. In another aspect, the portion of the code that includes the programming error is not included in the modified snippet. In an example implementation, the control logic 514 causes the artificial intelligence model 516 to correct the programming error by providing a second artificial intelligence prompt, which is included in the AI prompt(s) 540, together with at least a portion of the code that includes the programming error as second inputs to the artificial intelligence model 516. In accordance with this implementation, the portion of the code that includes the programming error is included in the snippet(s) 542. In an example, the control logic 514 may generate a system-generated prompt that includes at least a portion of the code 538 that includes the programming error. In accordance, with this example, the control logic 514 provides the second artificial intelligence prompt together with the system-generated prompt, which includes context for the second artificial intelligence prompt, as the second inputs to the artificial intelligence model 516.

In an aspect of the error fixing embodiment, the processed version of the modified snippet that is caused to be displayed at step 210 includes an error notification that indicates the programming error.

In another aspect of the error fixing embodiment, the method of flowchart 200 further includes detecting initiation of a keyboard shortcut. In an example implementation, the detection logic 522 detects initiation of a keyboard shortcut 578. In accordance with this implementation, the detection logic 522 generates a display instruction 525, which instructs the user interface generation logic 512 to provide a second interface element that is configured to receive the second artificial intelligence prompt. For example, detection of the initiation of the keyboard shortcut 578 may trigger the detection logic 522 to generate the display instruction 525. In accordance with this aspect, the method of flowchart 200 further includes, based at least on initiation of the keyboard shortcut, providing a second interface element to the user. The second interface element is configured to receive the second artificial intelligence prompt. In an example implementation, based at least on receipt of the display instruction 552 (e.g., based at least on the display instruction 552 instructing the user interface generation logic 512 to provide the second interface element), the user interface generation logic 512 provides the second interface element, which is configured to receive the second artificial intelligence prompt, in the user interface 556, which is displayed to the user.

In an example documentation embodiment, the method of flowchart 200 further includes causing the artificial intelligence model to generate documentation regarding the snippet by providing a second artificial intelligence prompt that requests the documentation regarding the snippet together with the snippet, which includes context regarding the second artificial intelligence prompt, as second inputs to the artificial intelligence model. In an example implementation, the control logic 514 causes the artificial intelligence model 516 to generate the documentation regarding the snippet by providing the second artificial intelligence prompt together with the snippet, which includes context regarding the second artificial intelligence prompt, as second inputs to the artificial intelligence model 516. In accordance with this implementation, the AI prompt(s) 540 include the second artificial intelligence prompt. In further accordance with this implementation, the snippet(s) 542 include the snippet.

In an aspect of the documentation embodiment, the method of flowchart 200 further includes identifying a programming language in which the code is written. In an example implementation, the control logic 514 identifies a programming language in which the code 538 is written. In accordance with this aspect, the artificial intelligence model is caused to generate the documentation in a style that corresponds to (e.g., is specific to) the programming language. For instance, contextual information that identifies the programming language may be provided together with the second artificial intelligence prompt and the snippet as the second inputs to the artificial intelligence model.

In an example test embodiment, the method of flowchart 200 further includes causing the artificial intelligence model to generate a test that is configured to test at least a portion of the code by providing a second artificial intelligence prompt that requests the test, which is configured to test at least the portion of the code, together with at least the portion of the code, which includes context regarding the second artificial intelligence prompt, as second inputs to the artificial intelligence model. In an example implementation, the control logic 514 causes the artificial intelligence model 516 to generate a test that is configured to test at least a portion of the code 538 by providing the second artificial intelligence prompt together with at least the portion of the code 538, which includes context regarding the second artificial intelligence prompt, as second inputs to the artificial intelligence model 516. In accordance with this implementation, the AI prompt(s) 540 include the second artificial intelligence prompt. In further accordance with this implementation, the snippet(s) 542 include at least the portion of the code 538.

In any one or more of the error fixing embodiment, the documentation embodiment, and/or the test embodiment mentioned described above, the method of flowchart 200 may include providing a second interface element that enables a user to provide the second artificial intelligence prompt. In an example implementation, the user interface generation logic 512 provides the second interface element. The second artificial intelligence prompt may be received from the user via the second interface element. The second artificial intelligence prompt in each of the error fixing embodiment, the documentation embodiment, and the test embodiment may have a respective predefined syntax. For instance, the predefined syntax may be defined prior to the second artificial intelligence prompt being received. In the error fixing embodiment, the predefined syntax for the second artificial intelligence prompt may include “/fix”. In the documentation embodiment, the predefined syntax for the second artificial intelligence prompt may include “/doc”. In the test embodiment, the predefined syntax for the second artificial intelligence prompt may include “/test”. These examples of the predefined syntax are provided for illustrative purposes and are not intended to be limiting. It will be recognized that the predefined syntax can be any suitable syntax.

By using a predefined syntax, the process for writing the second artificial intelligence prompt may be accelerated. For instance, using the predefined syntax may increase efficiency of the computing system (e.g., computing system 500) that receives the second artificial intelligence prompt and/or the user who generates the second artificial intelligence prompt. By using the predefined syntax, a type of information that is to be provided in response to the second artificial intelligence prompt may be determined. In an example implementation, the snippet processing logic 518 determines the type of the information that is to be provided. For instance, if the user requests a documentation comment, a determination may be made that the user expects to receive descriptive text rather than source code. Accordingly, a determination may be made to provide a response to the second artificial intelligence prompt that includes only the descriptive text. For example, if a response to the second artificial intelligence prompt that is received from the artificial intelligence model includes the descriptive text and the source code, the source code may be removed from the response before the response is provided to the user. In an example implementation, the snippet processing logic 518 provides the determined type of the information. In the example mentioned above, the snippet processing logic 518 may remove the source code from the response before providing the response to the user.

In another example embodiment, the method of flowchart 200 further includes determining that replacement of the snippet in the code with the modified snippet causes the code to include a programming error. In an example implementation, the error determination logic 534 determines that replacement of the snippet in the code 538 with the modified snippet causes the code 538 to include a programming error. In accordance with this implementation, the error determination logic 534 generates a change recommendation instruction 572, which instructs the recommendation logic 520 to recommend changing the modified snippet to include a specified change, which is configured to correct the programming error. In accordance with this embodiment, the method of flowchart 200 further includes providing a recommendation that recommends changing the modified snippet to include a specified change, which is configured to correct the programming error. For example, the specified change may be a changed spelling for a misspelled variable name or a misspelled function name in the modified snippet. It will be recognized that a variable name is a name of a variable, and function name is a name of a function. In an example implementation, the recommendation logic 520 provides a recommendation 574 that recommends changing the modified snippet to include the specified change that is configured to correct the programming error.

In an aspect of this embodiment, the processed version of the modified snippet that is caused to be displayed at step 210 includes an error notification that indicates the programming error.

In yet another example embodiment, the method of flowchart 200 further includes detecting creation of a function in the modified code snippet while the processed version of the modified code snippet is displayed via the user interface. In an example implementation, the function determination logic 532 detects the creation of the function in the modified code snippet while the processed version of the modified code snippet is displayed via the user interface 556. In accordance with this embodiment, the method of flowchart 200 further includes providing, in the user interface, recommended code to be included in the function by using intelligent code completion functionality of the developer tool. For instance, the recommended code may be presented in the user interface as ghost text, which may distinguish the recommended code from other code, which is written by the developer, of the function. In an aspect, the intelligent code completion functionality is autocomplete+™ functionality in the Atom™ source code editor. In another aspect, the intelligent code completion functionality is IntelliSense® functionality in Visual Studio Code™ source code editor. In an example implementation, the function determination logic 532 provides, in the user interface 556, recommended code 548 to be included in the function by using intelligent code completion functionality of the developer tool.

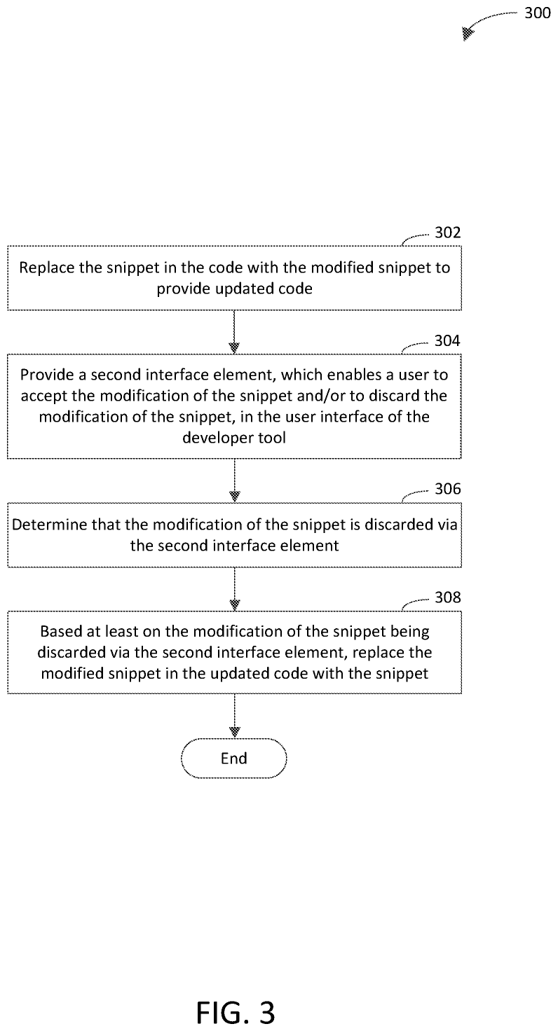

In still another example embodiment, the method of flowchart 200 further includes one or more of the steps shown in flowchart 300 of FIG. 3. As shown in FIG. 3, the method of flowchart 300 begins at step 302. In step 302, the snippet in the code is replaced with the modified snippet to provide updated code. In an example implementation, the first snippet replacement logic 524 replaces the snippet in the code 538 with the modified snippet to provide updated code 564.

At step 304, a second interface element, which enables a user to accept the modification of the snippet and/or to discard the modification of the snippet, is provided in the user interface of the developer tool. In an aspect, the second interface element further enables the user to change the modification of the snippet. In an example implementation, the user interface generation logic 512 provides a second interface element, which enables the user to accept the modification of the snippet and/or to discard the modification of the snippet, in the user interface 556 of the developer tool.

At step 306, a determination is made that the modification of the snippet is discarded via the second interface element. In an example implementation, the discarding determination logic 526 determines that the modification of the snippet is discarded via the second interface element. For example, the discarding determination logic 526 may make the determination based on (e.g., based at least on) receipt of a modification discarding indicator 566, which indicates that the modification of the snippet is discarded via the second interface element. For instance, generation of the modification discarding indicator 566 may be triggered by the user providing a user-generated instruction via the second interface element, which indicates that the modification of the snippet is discarded. In accordance with this implementation, the discarding determination logic 526 generates a snippet replacement instruction 546 based on the determination that the modification of the snippet is discarded via the second interface element. The snippet replacement instruction 546 instructs the second snippet replacement logic 528 to replace the modified snippet in the updated code 564 with the snippet.

At step 308, based at least on the modification of the snippet being discarded via the second interface element, the modified snippet in the updated code is replaced with the snippet. In an example implementation, the second snippet replacement logic 528 replaces the modified snippet in the updated code 564 with the snippet based at least on receipt of the snippet replacement instruction 546 (e.g., based at least on the snippet replacement instruction 546 instructing the second snippet replacement logic 528 to replace the modified snippet in the updated code 564 with the snippet).

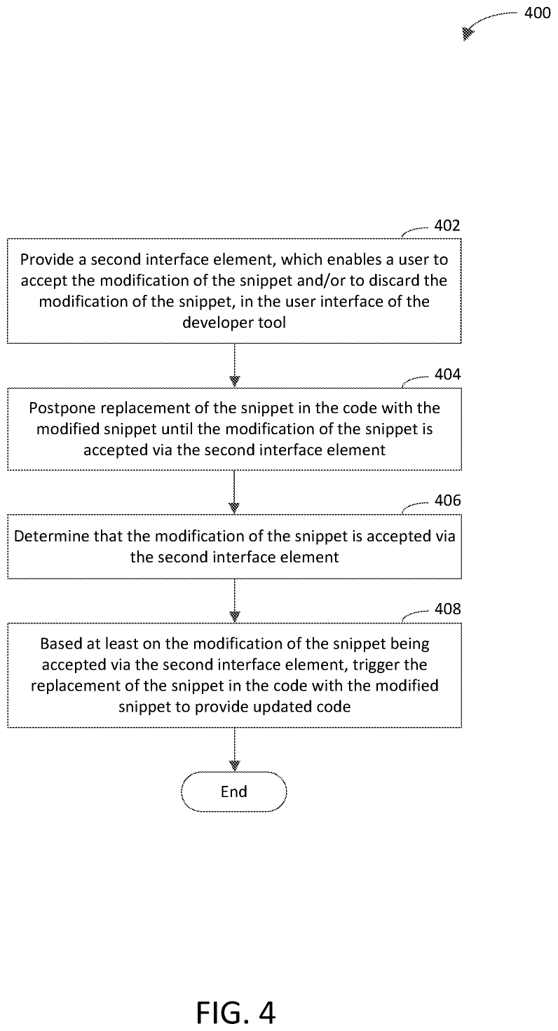

In yet another example embodiment, the method of flowchart 200 further includes one or more of the steps shown in flowchart 400 of FIG. 4. As shown in FIG. 4, the method of flowchart 400 begins at step 402. In step 402, a second interface element, which enables a user to accept the modification of the snippet and/or to discard the modification of the snippet, is provided in the user interface of the developer tool. In an aspect, the second interface element further enables the user to change the modification of the snippet. In an example implementation, the user interface generation logic 512 provides a second interface element, which enables the user to accept the modification of the snippet and/or to discard the modification of the snippet, in the user interface 556 of the developer tool.

At step 404, replacement of the snippet in the code with the modified snippet is postponed until the modification of the snippet is accepted via the second interface element. In an example implementation, the replacement postponing logic 530 postpones replacement of the snippet in the code 538 with the modified snippet until the modification of the snippet is accepted via the second interface element.

At step 406, a determination is made that the modification of the snippet is accepted via the second interface element. In an example implementation, the replacement postponing logic 530 determines that the modification of the snippet is accepted via the second interface element. For example, the replacement postponing logic 530 may make the determination based on receipt of a modification acceptance indicator 570, which indicates that the modification of the snippet is accepted via the second interface element. For instance, generation of the modification acceptance indicator 570 may be triggered by the user providing a user-generated instruction via the second interface element, which indicates that the modification of the snippet is accepted. In accordance with this implementation, the replacement postponing logic 530 generates a triggering instruction 568 based on the determination that the modification of the snippet is accepted via the second interface element. The triggering instruction 568 instructs the first snippet replacement logic 524 to replace the snippet in the code 538 with the modified snippet.

At step 408, based at least on the modification of the snippet being accepted via the second interface element, the replacement of the snippet in the code with the modified snippet is triggered to provide updated code. In an example implementation, the first snippet replacement logic 524 triggers the replacement of the snippet in the code 538 with the modified snippet to provide updated code 564 based at least on receipt of the triggering instruction 568 (e.g., based at least on the triggering instruction 568 instructing the first snippet replacement logic 524 to replace the snippet in the code 538 with the modified snippet).

It will be recognized that the computing system 500 may not include one or more of the AI-modified code recommendation logic 508, the user interface generation logic 512, the control logic 514, the artificial intelligence model 516, the snippet processing logic 518, the recommendation logic 520, the detection logic 522, the first snippet replacement logic 524, the discarding determination logic 526, the second snippet replacement logic 528, the replacement postponing logic 530, the function determination logic 532, and/or the error determination logic 534. Furthermore, the computing system 500 may include components in addition to or in lieu of the AI-modified code recommendation logic 508, the user interface generation logic 512, the control logic 514, the artificial intelligence model 516, the snippet processing logic 518, the recommendation logic 520, the detection logic 522, the first snippet replacement logic 524, the discarding determination logic 526, the second snippet replacement logic 528, the replacement postponing logic 530, the function determination logic 532, and/or the error determination logic 534.

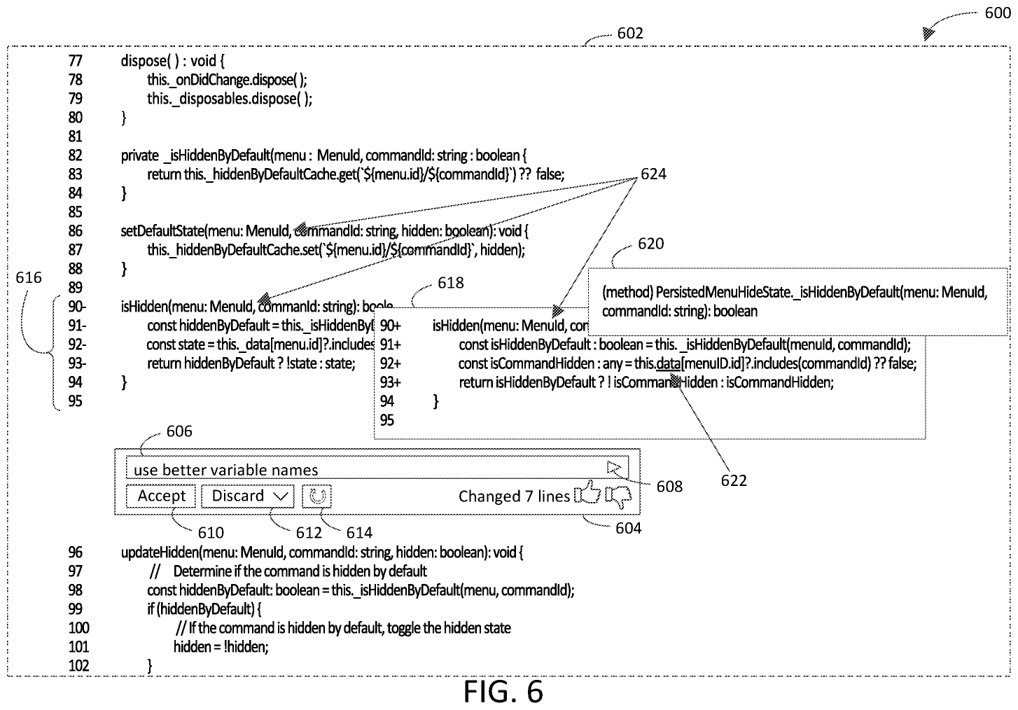

FIG. 6 depicts example code 600 presented in a user interface 602 of a developer tool in accordance with an embodiment. As shown in FIG. 6, the user interface 602 includes an input box 604. For example, AI-modified code recommendation logic (e.g., AI-modified code recommendation logic 108 or AI-modified code recommendation logic 508) may have provided the input box 604 in the user interface 602 based on (e.g., based at least on) detecting that the code 600 was being developed in the developer tool.

The input box 604 includes a text field 606, an acceptance button 610, a discard button 612, and a refresh button 614. The text field 606 is configured to receive an artificial intelligence prompt that specifies a modification to be performed on the code 600. For purposes of illustration, assume that a developer of the code 600 has selected a snippet 616 of the code 600 that extends from line 90 through line 95 and has then entered a prompt of “use better variable names” in the text box 606. It will be recognized that any suitable portion (e.g., none or all) of the code 600 may be selected, and any suitable prompt may be entered into the text box 606. For instance, the snippet 616 may be identified based on placement of a cursor rather than selection by the developer. Upon entering the prompt, the developer may press an “enter” button 608, which causes AI-modified code recommendation logic (e.g., AI-modified code recommendation logic 108 or AI-modified code recommendation logic 508) to automatically cause an artificial intelligence model (e.g., artificial intelligence model 516) to modify at least the snippet 616 to include better variable names, as requested in the prompt. The AI-modified code recommendation logic automatically causes the artificial intelligence model to perform the modification by providing the prompt together with at least the snippet 616 to the artificial intelligence model. The artificial intelligence model processes the prompt and at least the snippet 616, which includes context for the prompt, to provide a modified snippet.

The AI-modified code recommendation logic receives the modified code snippet from the artificial intelligence model. The AI-modified code recommendation logic processes the modified code snippet using a language intelligence tool of the developer tool to provide a processed version of the modified snippet 618. The AI-modified code recommendation logic causes the processed version of the modified snippet 618 to be displayed in the user interface 602. By causing the processed version of the modified snippet 618 to be displayed in the user interface 602, the AI-modified code recommendation logic recommends replacing the snippet 616 with the modified snippet. The processed version of the modified snippet 618 is editable and includes language features that are provided by using the language intelligence tool of the developer tool.

The developer of the code 600 may accept the modification of the snippet 616 by selecting the accept button 610. The developer of the code 600 may discard the modification of the snippet 616 by selecting the discard button 612. The developer may refresh the prompt, which will trigger the AI-modified code recommendation logic to re-submit the prompt to the artificial intelligence model, by selecting the refresh button 614.

Some of the language features that may be provided by using the language intelligence tool of the developer tool will now be discussed. For instance, the developer may hover over a symbol in the processed version of the modified snippet 618, which triggers the AI-modified code recommendation logic to provide a window 620 in the user interface 602. In this example, the developer hovers over the symbol “_isHiddenByDefault” at line 91 of the processed version of the modified snippet 618, which triggers the window 620 to be provided. It will be recognized that _isHiddenByDefault is defined at line 82 of the code 602. The window 620 includes information about the symbol (e.g., a description of the symbol).

The AI-modified code recommendation logic identifies a programming error in the modified snippet and provides an error indicator 622 in the processed version of the modified snippet 618, which indicates a symbol that is associated with the programming error. For instance, the AI-modified code recommendation logic recognizes that the symbol “_data” has been changed to “data”, and this has resulted in the programming error. By identifying the programming error in the processed version of the modified snippet 618, the AI-modified code recommendation logic enables the developer of the code 602 to see (and potentially correct) the programming error prior to acceptance of the modification. It should be noted that debugging functionality of the developer tool, which is available to fix errors in the code 600, is also available to fix errors in the modified snippet.

The language features, which are provided by using the language intelligence tool of the developer tool, are applicable across the code 600 and the processed version of the modified snippet 618. For instance, by using the language intelligence tool, the AI-modified code recommendation logic may highlight (e.g., simultaneously highlight) all instances of a particular symbol (e.g., MenuId 624 in this example) in the code 600 and in the processed version of the modified snippet 618.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the AI-modified code recommendation logic 108, the AI-modified code recommendation logic 508, the user interface generation logic 512, the control logic 514, the artificial intelligence model 516, the snippet processing logic 518, the recommendation logic 520, the detection logic 522, the first snippet replacement logic 524, the discarding determination logic 526, the second snippet replacement logic 528, the replacement postponing logic 530, the function determination logic 532, the error determination logic 534, flowchart 200, flowchart 300, and/or flowchart 400 may be implemented in hardware, software, firmware, or any combination thereof.

For example, any one or more of the AI-modified code recommendation logic 108, the AI-modified code recommendation logic 508, the user interface generation logic 512, the control logic 514, the artificial intelligence model 516, the snippet processing logic 518, the recommendation logic 520, the detection logic 522, the first snippet replacement logic 524, the discarding determination logic 526, the second snippet replacement logic 528, the replacement postponing logic 530, the function determination logic 532, the error determination logic 534, flowchart 200, flowchart 300, and/or flowchart 400 may be implemented, at least in part, as computer program code configured to be executed in one or more processors.

In another example, any one or more of the AI-modified code recommendation logic 108, the AI-modified code recommendation logic 508, the user interface generation logic 512, the control logic 514, the artificial intelligence model 516, the snippet processing logic 518, the recommendation logic 520, the detection logic 522, the first snippet replacement logic 524, the discarding determination logic 526, the second snippet replacement logic 528, the replacement postponing logic 530, the function determination logic 532, the error determination logic 534, flowchart 200, flowchart 300, and/or flowchart 400 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

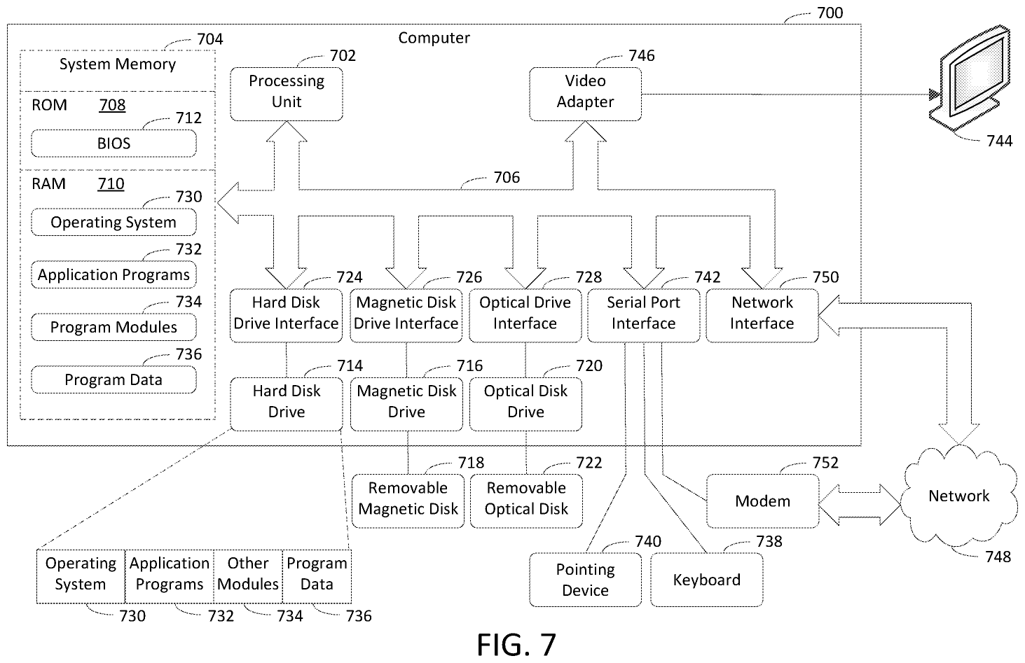

(A1) An example system (FIG. 1, 102A-102M, 106A-106N; FIG. 5, 500; FIG. 7, 700) comprises a processor system (FIG. 7, 702) and a memory (FIG. 7, 704, 708, 710) that stores computer-executable instructions. The computer-executable instructions are executable by the processor system to, based at least on code (FIG. 5, 538) being developed in a developer tool, provide (FIG. 2, 202) an interface element in a user interface (FIG. 5, 556) of the developer tool. The interface element is configured to receive an artificial intelligence prompt (FIG. 5, 560) that specifies a modification to be performed on the code. The computer-executable instructions are executable by the processor system further to, based at least on receipt of the artificial intelligence prompt via the interface element, automatically cause (FIG. 2, 204) an artificial intelligence model (FIG. 5, 516) to perform the modification on at least a snippet (FIG. 5, 542) of the code by providing the artificial intelligence prompt together with the snippet as inputs to the artificial intelligence model. The snippet includes context regarding the artificial intelligence prompt. The computer-executable instructions are executable by the processor system further to receive (FIG. 2, 206) a modified snippet (FIG. 5, 562) from the artificial intelligent model. The modified snippet results from the artificial intelligence model performing the modification specified by the artificial intelligence prompt. The computer-executable instructions are executable by the processor system further to process (FIG. 2, 208) the modified snippet using a language intelligence tool (FIG. 5, 544) of the developer tool to provide a processed version of the modified snippet (FIG. 5, 554). The computer-executable instructions are executable by the processor system further to provide (FIG. 2, 210) a recommendation (FIG. 5, 574) to replace the snippet in the code with the modified snippet by causing the processed version of the modified snippet to be displayed via the user interface of the developer tool.

(A2) In the example system of A1, wherein the computer-executable instructions are executable by the processor system to: cause the snippet and the processed version of the modified snippet to be displayed simultaneously via the user interface.

(A3) In the example system of any of A1-A2, wherein the computer-executable instructions are executable by the processor system further to: detect a gesture regarding a symbol, which is included in the processed version of the modified snippet, while the processed version of the modified snippet is displayed via the user interface; and based at least on the gesture, provide information about the symbol in an interface element of the user interface.

(A4) In the example system of any of A1-A3, wherein the computer-executable instructions are executable by the processor system to: annotate the modified snippet using the language intelligence tool of the developer tool to provide the processed version of the modified snippet having an annotation; and cause the processed version of the modified snippet, including the annotation, to be displayed via the user interface.

(A5) In the example system of any of A1-A4, wherein the computer-executable instructions are executable by the processor system to: highlight instances of a designated symbol in the modified snippet using the language intelligence tool of the developer tool to provide the processed version of the modified snippet; and cause the processed version of the modified snippet, including highlighted instances of the designated symbol, to be displayed via the user interface.

(A6) In the example system of any of A1-A5, wherein the computer-executable instructions are executable by the processor system to: distinguish a designated portion of the modified snippet from a remainder of the modified snippet by marking the designated portion with an error indicator using the language intelligence tool of the developer tool to provide the processed version of the modified snippet, the error indicator indicating that a programming error occurs with regard to the designated portion of the modified snippet; and cause the processed version of the modified snippet, which includes the error indicator, to be displayed via the user interface.

(A7) In the example system of any of A1-A6, wherein the computer-executable instructions are executable by the processor system further to: provide a second interface element, which enables a user to at least one of accept the modification of the snippet or discard the modification of the snippet, in the user interface of the developer tool.

(A8) In the example system of any of A1-A7, wherein the computer-executable instructions are executable by the processor system further to: replace the snippet in the code with the modified snippet to provide updated code; determine that the modification of the snippet is discarded via the second interface element; and based at least on the modification of the snippet being discarded via the second interface element, replace the modified snippet in the updated code with the snippet.

(A9) In the example system of any of A1-A8, wherein the computer-executable instructions are executable by the processor system further to: postpone replacement of the snippet in the code with the modified snippet until the modification of the snippet is accepted via the second interface element; determine that the modification of the snippet is accepted via the second interface element; and based at least on the modification of the snippet being accepted via the second interface element, trigger the replacement of the snippet in the code with the modified snippet to provide updated code.

(A10) In the example system of any of A1-A9, wherein the second interface element further enables the user to change the modification of the snippet.

(A11) In the example system of any of A1-A10, wherein the computer-executable instructions are executable by the processor system to: cause the processed version of the modified snippet to be displayed via the user interface based at least on a cursor being located in the snippet at a time instance at which the artificial intelligence prompt is received.

(A12) In the example system of any of A1-A11, wherein the computer-executable instructions are executable by the processor system to: cause the processed version of the modified snippet to be displayed via the user interface based at least on the artificial intelligence prompt being received while an entirety of text that is included in the snippet is selected in accordance with a user-generated instruction.

(A13) In the example system of any of A1-A12, wherein the computer-executable instructions are executable by the processor system further to: determine that replacement of the snippet in the code with the modified snippet causes the code to include a programming error; and cause the artificial intelligence model to correct the programming error by providing a second artificial intelligence prompt, which specifies that the programming error is to be corrected, together with at least a portion of the code that includes the programming error as second inputs to the artificial intelligence model, the portion of the code including context regarding the second artificial intelligence prompt.

(A14) In the example system of any of A1-A13, wherein the computer-executable instructions are executable by the processor system further to: cause the artificial intelligence model to generate documentation regarding the snippet by providing a second artificial intelligence prompt that requests the documentation regarding the snippet together with the snippet, which includes context regarding the second artificial intelligence prompt, as second inputs to the artificial intelligence model.

(A15) In the example system of any of A1-A14, wherein the computer-executable instructions are executable by the processor system further to: cause the artificial intelligence model to generate a test that is configured to test at least a portion of the code by providing a second artificial intelligence prompt that requests the test, which is configured to test at least the portion of the code, together with at least the portion of the code, which includes context regarding the second artificial intelligence prompt, as second inputs to the artificial intelligence model.

(A16) In the example system of any of A1-A15, wherein the computer-executable instructions are executable by the processor system further to: determine that replacement of the snippet in the code with the modified snippet causes the code to include a programming error; and provide a recommendation that recommends changing the modified snippet to include a specified change, which is configured to correct the programming error.

(A17) In the example system of any of A1-A16, wherein the computer-executable instructions are executable by the processor system further to: detect creation of a function in the modified code snippet while the processed version of the modified code snippet is displayed via the user interface; and provide, in the user interface, recommended code to be included in the function by using intelligent code completion functionality of the developer tool.

(B1) An example method is implemented by a computing system (FIG. 1, 102A-102M, 106A-106N; FIG. 5, 500; FIG. 7, 700). The method comprises, based at least on code (FIG. 5, 538) being developed in a developer tool, providing (FIG. 2, 202) an interface element in a user interface (FIG. 5, 556) of the developer tool. The interface element is configured to receive an artificial intelligence prompt (FIG. 5, 560) that specifies a modification to be performed on the code. The method further comprises, based at least on receipt of the artificial intelligence prompt via the interface element, automatically causing (FIG. 2, 204) an artificial intelligence model (FIG. 5, 516) to perform the modification on at least a snippet (FIG. 5, 542) of the code by providing the artificial intelligence prompt together with the snippet as inputs to the artificial intelligence model. The snippet includes context regarding the artificial intelligence prompt. The method further comprises receiving (FIG. 2, 206) a modified snippet (FIG. 5, 562) from the artificial intelligent model. The modified snippet results from the artificial intelligence model performing the modification specified by the artificial intelligence prompt. The method further comprises processing (FIG. 2, 208) the modified snippet using a language intelligence tool (FIG. 5, 544) of the developer tool to provide a processed version of the modified snippet (FIG. 5, 554). The method further comprises providing (FIG. 2, 210) a recommendation (FIG. 5, 574) to replace the snippet in the code with the modified snippet by causing the processed version of the modified snippet to be displayed via the user interface of the developer tool.

(B2) In the example method of B1, wherein causing the processed version of the modified snippet to be displayed comprises: causing the snippet and the processed version of the modified snippet to be displayed simultaneously via the user interface.

(B3) In the example method of any of B1-B2, further comprising: detecting a gesture regarding a symbol, which is included in the processed version of the modified snippet, while the processed version of the modified snippet is displayed via the user interface; and based at least on the gesture, providing information about the symbol in an interface element of the user interface.

(B4) In the example method of any of B1-B3, wherein processing the modified snippet comprises: annotating the modified snippet using the language intelligence tool of the developer tool to provide the processed version of the modified snippet having an annotation; and wherein causing the processed version of the modified snippet to be displayed via the user interface comprises: causing the processed version of the modified snippet, including the annotation, to be displayed via the user interface.

(B5) In the example method of any of B1-B4, wherein processing the modified snippet comprises: highlighting instances of a designated symbol in the modified snippet using the language intelligence tool of the developer tool to provide the processed version of the modified snippet; and wherein causing the processed version of the modified snippet to be displayed via the user interface comprises: causing the processed version of the modified snippet, including highlighted instances of the designated symbol, to be displayed via the user interface.

(B6) In the example method of any of B1-B5, wherein processing the modified snippet comprises: distinguishing a designated portion of the modified snippet from a remainder of the modified snippet by marking the designated portion with an error indicator using the language intelligence tool of the developer tool to provide the processed version of the modified snippet, the error indicator indicating that a programming error occurs with regard to the designated portion of the modified snippet; and wherein causing the processed version of the modified snippet to be displayed via the user interface comprises: causing the processed version of the modified snippet, which includes the error indicator, to be displayed via the user interface.

(B7) In the example method of any of B1-B6, further comprising: providing a second interface element, which enables a user to at least one of accept the modification of the snippet or discard the modification of the snippet, in the user interface of the developer tool.

(B8) In the example method of any of B1-B7, further comprising: replacing the snippet in the code with the modified snippet to provide updated code; determining that the modification of the snippet is discarded via the second interface element; and based at least on the modification of the snippet being discarded via the second interface element, replacing the modified snippet in the updated code with the snippet.

(B9) In the example method of any of B1-B8, further comprising: postponing replacement of the snippet in the code with the modified snippet until the modification of the snippet is accepted via the second interface element; determining that the modification of the snippet is accepted via the second interface element; and based at least on the modification of the snippet being accepted via the second interface element, triggering the replacement of the snippet in the code with the modified snippet to provide updated code.

(B10) In the example method of any of B1-B9, wherein the second interface element further enables the user to change the modification of the snippet.

(B11) In the example method of any of B1-B10, wherein causing the processed version of the modified snippet to be displayed via the user interface is performed based at least on a cursor being located in the snippet at a time instance at which the artificial intelligence prompt is received.

(B12) In the example method of any of B1-B11, wherein causing the processed version of the modified snippet to be displayed via the user interface is performed based at least on the artificial intelligence prompt being received while an entirety of text that is included in the snippet is selected in accordance with a user-generated instruction.

(B13) In the example method of any of B1-B12, further comprising: determining that replacement of the snippet in the code with the modified snippet causes the code to include a programming error; and causing the artificial intelligence model to correct the programming error by providing a second artificial intelligence prompt, which specifies that the programming error is to be corrected, together with at least a portion of the code that includes the programming error as second inputs to the artificial intelligence model, the portion of the code including context regarding the second artificial intelligence prompt.

(B14) In the example method of any of B1-B13, further comprising: causing the artificial intelligence model to generate documentation regarding the snippet by providing a second artificial intelligence prompt that requests the documentation regarding the snippet together with the snippet, which includes context regarding the second artificial intelligence prompt, as second inputs to the artificial intelligence model.

(B15) In the example method of any of B1-B14, further comprising: causing the artificial intelligence model to generate a test that is configured to test at least a portion of the code by providing a second artificial intelligence prompt that requests the test, which is configured to test at least the portion of the code, together with at least the portion of the code, which includes context regarding the second artificial intelligence prompt, as second inputs to the artificial intelligence model.

(B16) In the example method of any of B1-B15, further comprising: determining that replacement of the snippet in the code with the modified snippet causes the code to include a programming error; and providing a recommendation that recommends changing the modified snippet to include a specified change, which is configured to correct the programming error.

(B17) In the example method of any of B1-B16, further comprising: detecting creation of a function in the modified code snippet while the processed version of the modified code snippet is displayed via the user interface; and providing, in the user interface, recommended code to be included in the function by using intelligent code completion functionality of the developer tool.

(C1) An example computer program product (FIG. 7, 718, 722) comprising a computer-readable storage medium having instructions recorded thereon for enabling a processor-based system (FIG. 1, 102A-102M, 106A-106N; FIG. 5, 500; FIG. 7, 700) to perform operations. The operations comprise, based at least on code (FIG. 5, 538) being developed in a developer tool, providing (FIG. 2, 202) an interface element in a user interface (FIG. 5, 556) of the developer tool. The interface element is configured to receive an artificial intelligence prompt (FIG. 5, 560) that specifies a modification to be performed on the code. The operations further comprise, based at least on receipt of the artificial intelligence prompt via the interface element, automatically causing (FIG. 2, 204) an artificial intelligence model (FIG. 5, 516) to perform the modification on at least a snippet (FIG. 5, 542) of the code by providing the artificial intelligence prompt together with the snippet as inputs to the artificial intelligence model. The snippet includes context regarding the artificial intelligence prompt. The operations further comprise receiving (FIG. 2, 206) a modified snippet (FIG. 5, 562) from the artificial intelligent model. The modified snippet results from the artificial intelligence model performing the modification specified by the artificial intelligence prompt. The operations further comprise processing (FIG. 2, 208) the modified snippet using a language intelligence tool (FIG. 5, 544) of the developer tool to provide a processed version of the modified snippet (FIG. 5, 554). The operations further comprise providing (FIG. 2, 210) a recommendation (FIG. 5, 574) to replace the snippet in the code with the modified snippet by causing the processed version of the modified snippet to be displayed via the user interface of the developer tool.

### III. Example Computer System

FIG. 7 depicts an example computer 700 in which embodiments may be implemented. Any one or more of the user devices 102A-102M and/or any one or more of the servers 106A-106N shown in FIG. 1 and/or the computing system 500 shown in FIG. 5 may be implemented using computer 700, including one or more features of computer 700 and/or alternative features. Computer 700 may be a general-purpose computing device in the form of a conventional personal computer, a mobile computer, or a workstation, for example, or computer 700 may be a special purpose computing device. The description of computer 700 provided herein is provided for purposes of illustration, and is not intended to be limiting. Embodiments may be implemented in further types of computer systems, as would be known to persons skilled in the relevant art(s).

As shown in FIG. 7, computer 700 includes a processing unit 702, a system memory 704, and a bus 706 that couples various system components including system memory 704 to processing unit 702. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computer 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 730, one or more application programs 732, other program modules 734, and program data 736. Application programs 732 or program modules 734 may include, for example, computer program logic for implementing any one or more of (e.g., at least a portion of) the AI-modified code recommendation logic 108, the AI-modified code recommendation logic 508, the user interface generation logic 512, the control logic 514, the artificial intelligence model 516, the snippet processing logic 518, the recommendation logic 520, the detection logic 522, the first snippet replacement logic 524, the discarding determination logic 526, the second snippet replacement logic 528, the replacement postponing logic 530, the function determination logic 532, the error determination logic 534, flowchart 200 (including any step of flowchart 200), flowchart 300 (including any step of flowchart 300), and/or flowchart 400 (including any step of flowchart 400), as described herein.

A user may enter commands and information into the computer 700 through input devices such as keyboard 738 and pointing device 740. Other input devices (not shown) may include a microphone, joystick, game pad, satellite dish, scanner, touch screen, camera, accelerometer, gyroscope, or the like. These and other input devices are often connected to the processing unit 702 through a serial port interface 742 that is coupled to bus 706, but may be connected by other interfaces, such as a parallel port, game port, or a universal serial bus (USB).

A display device 744 (e.g., a monitor) is also connected to bus 706 via an interface, such as a video adapter 746. In addition to display device 744, computer 700 may include other peripheral output devices (not shown) such as speakers and printers.

Computer 700 is connected to a network 748 (e.g., the Internet) through a network interface or adapter 750, a modem 752, or other means for establishing communications over the network. Modem 752, which may be internal or external, is connected to bus 706 via serial port interface 742.

As used herein, the terms “computer program medium” and “computer-readable storage medium” are used to generally refer to media (e.g., non-transitory media) such as the hard disk associated with hard disk drive 714, removable magnetic disk 718, removable optical disk 722, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 732 and other program modules 734) may be stored on the hard disk, magnetic disk, optical disk, ROM, or RAM. Such computer programs may also be received via network interface 750 or serial port interface 742. Such computer programs, when executed or loaded by an application, enable computer 700 to implement features of embodiments discussed herein. Accordingly, such computer programs represent controllers of the computer 700.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
based at least on code being developed in a developer tool, provide an interface element in a user interface of the developer tool, the interface element configured to receive an artificial intelligence prompt that specifies a modification to be performed on the code;
based at least on receipt of the artificial intelligence prompt via the interface element, automatically cause an artificial intelligence model to perform the modification on at least a snippet of the code by providing the artificial intelligence prompt together with the snippet as inputs to the artificial intelligence model, the snippet including context regarding the artificial intelligence prompt;
receive a modified snippet from the artificial intelligence model, the modified snippet resulting from the artificial intelligence model performing the modification specified by the artificial intelligence prompt;
process the modified snippet using a language intelligence tool of the developer tool to provide a processed version of the modified snippet; and
provide a recommendation to replace the snippet in the code with the modified snippet by causing the processed version of the modified snippet to be displayed via the user interface of the developer tool.

2. The system of claim 1, wherein the computer-executable instructions are executable by the processor system further to:
provide a second interface element, which enables a user to at least one of accept the modification of the snippet or discard the modification of the snippet, in the user interface of the developer tool.

3. The system of claim 2, wherein the computer-executable instructions are executable by the processor system further to:
replace the snippet in the code with the modified snippet to provide updated code;
determine that the modification of the snippet is discarded via the second interface element; and
based at least on the modification of the snippet being discarded via the second interface element, replace the modified snippet in the updated code with the snippet.

4. The system of claim 2, wherein the computer-executable instructions are executable by the processor system further to:
postpone replacement of the snippet in the code with the modified snippet until the modification of the snippet is accepted via the second interface element;
determine that the modification of the snippet is accepted via the second interface element; and
based at least on the modification of the snippet being accepted via the second interface element, trigger the replacement of the snippet in the code with the modified snippet to provide updated code.

5. The system of claim 2, wherein the second interface element further enables the user to change the modification of the snippet.

6. The system of claim 1, wherein the computer-executable instructions are executable by the processor system to:
cause the processed version of the modified snippet to be displayed via the user interface based at least on a cursor being located in the snippet at a time instance at which the artificial intelligence prompt is received.

7. The system of claim 1, wherein the computer-executable instructions are executable by the processor system to:
cause the processed version of the modified snippet to be displayed via the user interface based at least on the artificial intelligence prompt being received while an entirety of text that is included in the snippet is selected in accordance with a user-generated instruction.

8. The system of claim 1, wherein the computer-executable instructions are executable by the processor system further to:
determine that replacement of the snippet in the code with the modified snippet causes the code to include a programming error; and
cause the artificial intelligence model to correct the programming error by providing a second artificial intelligence prompt, which specifies that the programming error is to be corrected, together with at least a portion of the code that includes the programming error as second inputs to the artificial intelligence model, the portion of the code including context regarding the second artificial intelligence prompt.

9. The system of claim 1, wherein the computer-executable instructions are executable by the processor system further to:
cause the artificial intelligence model to generate documentation regarding the snippet by providing a second artificial intelligence prompt that requests the documentation regarding the snippet together with the snippet, which includes context regarding the second artificial intelligence prompt, as second inputs to the artificial intelligence model.

10. The system of claim 1, wherein the computer-executable instructions are executable by the processor system further to:
cause the artificial intelligence model to generate a test that is configured to test at least a portion of the code by providing a second artificial intelligence prompt that requests the test, which is configured to test at least the portion of the code, together with at least the portion of the code, which includes context regarding the second artificial intelligence prompt, as second inputs to the artificial intelligence model.

11. The system of claim 1, wherein the computer-executable instructions are executable by the processor system further to:
determine that replacement of the snippet in the code with the modified snippet causes the code to include a programming error; and
provide a recommendation that recommends changing the modified snippet to include a specified change, which is configured to correct the programming error.

12. The system of claim 1, wherein the computer-executable instructions are executable by the processor system further to:
detect creation of a function in the modified code snippet while the processed version of the modified code snippet is displayed via the user interface; and
provide, in the user interface, recommended code to be included in the function by using intelligent code completion functionality of the developer tool.

13. A method implemented by a computing system, the method comprising:
based at least on code being developed in a developer tool, providing an interface element in a user interface of the developer tool, the interface element configured to receive an artificial intelligence prompt that specifies a modification to be performed on the code;
based at least on receipt of the artificial intelligence prompt via the interface element, automatically causing an artificial intelligence model to perform the modification on at least a snippet of the code by providing the artificial intelligence prompt together with the snippet as inputs to the artificial intelligence model, the snippet including context regarding the artificial intelligence prompt;
receiving a modified snippet from the artificial intelligent model, the modified snippet resulting from the artificial intelligence model performing the modification specified by the artificial intelligence prompt;
processing the modified snippet using a language intelligence tool of the developer tool to provide a processed version of the modified snippet; and
providing a recommendation to replace the snippet in the code with the modified snippet by causing the processed version of the modified snippet to be displayed via the user interface of the developer tool.

14. The method of claim 13, wherein causing the processed version of the modified snippet to be displayed comprises:
causing the snippet and the processed version of the modified snippet to be displayed simultaneously via the user interface.

15. The method of claim 13, further comprising:
detecting a gesture regarding a symbol, which is included in the processed version of the modified snippet, while the processed version of the modified snippet is displayed via the user interface; and
based at least on the gesture, providing information about the symbol in an interface element of the user interface.

16. The method of claim 13, wherein processing the modified snippet comprises:
annotating the modified snippet using the language intelligence tool of the developer tool to provide the processed version of the modified snippet having an annotation; and
wherein causing the processed version of the modified snippet to be displayed via the user interface comprises:
causing the processed version of the modified snippet, including the annotation, to be displayed via the user interface.

17. The method of claim 13, wherein processing the modified snippet comprises:
highlighting instances of a designated symbol in the modified snippet using the language intelligence tool of the developer tool to provide the processed version of the modified snippet; and
wherein causing the processed version of the modified snippet to be displayed via the user interface comprises:
causing the processed version of the modified snippet, including highlighted instances of the designated symbol, to be displayed via the user interface.

18. The method of claim 13, wherein processing the modified snippet comprises:
distinguishing a designated portion of the modified snippet from a remainder of the modified snippet by marking the designated portion with an error indicator using the language intelligence tool of the developer tool to provide the processed version of the modified snippet, the error indicator indicating that a programming error occurs with regard to the designated portion of the modified snippet; and
wherein causing the processed version of the modified snippet to be displayed via the user interface comprises:
causing the processed version of the modified snippet, which includes the error indicator, to be displayed via the user interface.

19. The method of claim 13, wherein causing the processed version of the modified snippet to be displayed via the user interface is performed based at least on a cursor being located in the snippet at a time instance at which the artificial intelligence prompt is received.

20. A computer program product comprising a computer-readable storage medium having instructions recorded thereon for enabling a processor-based system to perform operations, the operations comprising:
based at least on code being developed in a developer tool, providing an interface element in a user interface of the developer tool, the interface element configured to receive an artificial intelligence prompt that specifies a modification to be performed on the code;
based at least on receipt of the artificial intelligence prompt via the interface element, automatically causing an artificial intelligence model to perform the modification on at least a snippet of the code by providing the artificial intelligence prompt together with the snippet as inputs to the artificial intelligence model, the snippet including context regarding the artificial intelligence prompt;
receiving a modified snippet from the artificial intelligent model, the modified snippet resulting from the artificial intelligence model performing the modification specified by the artificial intelligence prompt;
processing the modified snippet using a language intelligence tool of the developer tool to provide a processed version of the modified snippet; and
providing a recommendation to replace the snippet in the code with the modified snippet by causing the processed version of the modified snippet to be displayed via the user interface of the developer tool.
